(19) United States
(12) Patent Application Publication
(10) Pub. No.: US 2022/0055130 A1
(43) Pub. Date: Feb. 24, 2022

(54) MAGNETIC TAPPING GUIDE DEVICE

(71) Applicant: Jin Liang, Dongguan (CN)

(72) Inventor: Jin Liang, Dongguan (CN)

(21) Appl. No.: 17/519,698

(22) Filed: Nov. 5, 2021

Related U.S. Application Data
(63) Continuation of application No. PCT/CN2019/103067, filed on Aug. 28, 2019.

(30) Foreign Application Priority Data
May 8, 2019 (CN) 201910380154.0

(51) Int. Cl. B23G 1/48; H01F 7/20

(52) U.S. Cl. CPC B23G 1/48; H01F 7/20

(57) ABSTRACT

The present application provides a magnetic tapping guide device to guide a tap for threading in a workpiece. The magnetic tapping guide device includes a guide seat configured to contact with the workpiece; a guide portion positioned outside the guide seat, having a pilot hole for guiding the tap; and a magnetic module positioned inside the guide seat, configured to provide a magnetic force to keep the guide seat in contact with the workpiece, the magnetic force of the magnetic module being adjustable.

### CROSS-REFERENCE TO RELATED APPLICATIONS

This application is a continuation-application of International (PCT) Patent Application No. PCT/CN2019/103067, filed on Aug. 28, 2019, which claims priority to Chinese Patent Application No. 201910380154.0, filed with the National Intellectual Property Administration of China on May 8, 2019, and entitled “MAGNETIC TAPPING GUIDE DEVICE ”, the entire contents of which are incorporated herein by reference.

### TECHNICAL FIELD

The present application relates to the field of tapping tools, more particularly, to a magnetic tapping guide device.

### BACKGROUND

Tapping usually is performed by threading a tap through a hole in a surface to be machined of a workpiece. Depending on the experience of an operator, balance in the force applied by both of his hands, uniformity of hardness distribution of the material, and other factors, the threaded hole is very likely to be skew. Therefore, it may lead to not only difficulty in mounting components, but also scrap products in worse situations.

A tapping guide device, also named tapping centralizer, is used to guide the tap for straight threading, and a related tapping guide device is fixed to a workpiece via a magnetic seat. However, when developing the present invention, the inventor found that the related tap guide is not easy to move, making it inconvenient to adjust the tap guide. Accordingly, an improvement based on the related art is desirable.

### SUMMARY

An embodiment of the present disclosure provides a magnetic tapping guide device configured to guide a tap for threading in a workpiece. The magnetic tapping guide device includes: a guide seat configured to contact with the workpiece; a guide portion positioned outside the guide seat and having a pilot hole for guiding the tap; and a magnetic module positioned inside the guide seat and configured to provide a magnetic force to keep the guide seat in contact with the workpiece, the magnetic force of the magnetic module being adjustable.

### BRIEF DESCRIPTION OF THE DRAWINGS

One or more embodiments are illustrated with reference to corresponding figures in the accompanying drawings and are not intended to limit embodiments; the same or similar reference signs in the drawings represent the same or similar elements, and the elements are not necessarily drawn to scale unless specified otherwise.

FIG. 1 is a perspective view of a magnetic tapping guide device according to an embodiment of the present application.

FIG. 2 is an exploded view of the magnetic tapping guide device shown in FIG. 1.

FIG. 3 is a cross-sectional view of the magnetic tapping guide device of FIG. 1 mounted on a workpiece.

FIG. 4 is a perspective view of the magnetic tapping guide device according to another embodiment of the present application.

### DETAILED DESCRIPTION

To facilitate the understanding of the application, the application will be described in more detail below in conjunction with the drawings and embodiments. It should be noted that when an element is referred to as being “fixed to” another element, the element can be directly on the other element, or one or more intervening elements may exist between them. When an element is referred to as being “connected” to another element, the element can be directly connected to the other element, or one or more intervening elements may exist between them. Terms like “vertical”, “horizontal”, “left”, “right” and so on used in this description are intended for illustrative purposes only.

Unless otherwise defined, all technical and scientific terms used in this description have the same meaning as commonly understood by those skilled in the technical field to which this application pertains. The terms used in the description of this application are intended only to describe embodiments, but not to limit the application. Such a term as “and/or” used in this description includes any and all combinations of one or more related listed items.

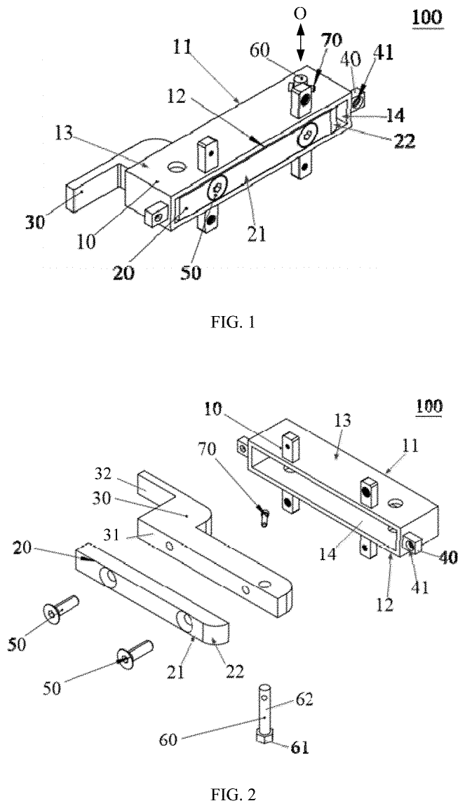

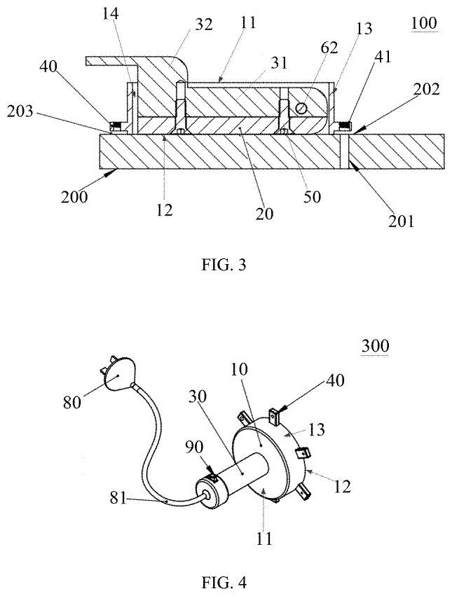

With reference to FIGS. 1 to 3, a magnetic tapping guide device 100 for guiding a tap for threading in a workpiece 200 provided by an embodiment of the present application is shown. The magnetic tapping guide device 100 includes a guide seat 10, a magnetic module 20, a handle 30, and a guide portion 40. Herein, the magnetic module 20, the handle 30, and the guide portion 40 are all provided on the guide seat 10.

In this embodiment, the guide seat 10 has an overall long block shape, and the guide seat 10 may have another shape, such as a cylindrical shape, a prismatic shape, or the like, as appropriate. The guide 10 has a top surface 11, a bottom surface 12, and a side surface 13. The top surface 11 and the bottom surface 12 are opposite, the side surface 13 is positioned between the top surface 11 and the bottom surface 12, and the side surface 13 encloses the top surface 11 and the bottom surface 12.

The bottom surface 12 is adapted to contact with the workpiece 200 when the magnetic tapping guide device 100 is guiding a tap for threading in the workpiece 200. The magnetic module 20 is mounted inside the guide seat 10 and configured to provide a magnetic force for attracting the bottom surface 12 to the workpiece 200. Since the magnetic module 20 is provided inside the guide seat 10, the bottom surface 12 can maintain a stable bond with the workpiece 200, which prevents the guide seat 10 from wobbling during tapping and thus avoids a reduced accuracy.

The guide seat 10 is provided with a mounting socket 14 penetrating the bottom surface 12 and the top surface 11. The mounting socket 14 is a square socket for receiving the magnetic module 20 and the handle 30, wherein the magnetic module 20 is close to the bottom surface 12 and the handle 30 is close to the top surface 11.

The magnetic force provided by the magnetic module 20 is adjustable. When the magnetic tapping guide device 100 is about to guide a tap for threading in the workpiece 200, the magnetic force provided by the magnetic module 20 is maximized to provide the strongest bond between the bottom surface 12 and the workpiece 200. Once the magnetic tapping guide device 100 finishes the operation of guiding the tap for threading in the workpiece 200, the magnetic force provided by the magnetic module 20 is minimized to facilitate the separation of the magnetic tapping guide device 100 from the workpiece 200.

In this embodiment, the magnetic module 20 is a permanent magnet, which may include, for example, a ferrite, neodymium iron boron, samarium cobalt magnet, aluminum nickel cobalt magnet, iron-chromium cobalt magnet, or the like.

The permanent magnet has an overall block shape, and the permanent magnet contacts the workpiece 200 when the bottom surface 12 contacts the workpiece 200.

The permanent magnet is rotatable relative to the guide seat 10 about a predetermined axis O so that an area where the permanent magnet contacts the workpiece 200 is changed, thereby making it adjustable the magnetic force provided by the permanent magnet. The predetermined axis is parallel to the bottom surface 12.

If the area where the permanent magnet contacts the workpiece 200 gets larger, the magnetic force provided by the permanent magnet is increased, instead, the magnetic force provided by the permanent magnet is reduced.

The permanent magnet has a contact plane 21 and a contact cambered surface 22, and the contact plane 21 and the contact cambered surface 22 are adjacent. When the magnetic tapping guide device is about to guide a tap for threading in the workpiece 200, either the contact plane 21 or the contact cambered surface 22 contacts the workpiece 200; herein, when the contact plane 21 contacts the workpiece 200, that is, when the permanent magnet contacts the workpiece 200 conformally, the permanent magnet provides the maximum magnetic force; when the contact cambered surface 22 contacts the workpiece 200, that is, when the permanent magnet contacts the workpiece 200 linearly, the permanent magnet provides the minimum magnetic force. Once one of the contact plane 21 and the contact cambered surface 22 is brought into contact with the workpiece 200, the other of the contact plane 21 and the contact cambered surface 22 can be brought into contact with the workpiece 200 by rotating the permanent magnet.

It will be appreciated that in this embodiment, the permanent magnet protrudes from the mounting socket 14 and is in direct contact with the workpiece 200 when the magnetic tapping guide device 100 is guiding a tap for threading in the workpiece 200; as appropriate, an opening of the mounting socket 14 at the bottom surface 12 may also be closed to prevent the permanent magnet from contacting the workpiece 200, and the magnetic force provided by the permanent magnet can be changed by only changing an angle of the contact plane 21; when the contact plane 21 is parallel to the bottom surface 12, the contact plane 21 faces directly the workpiece 200, in which case the permanent magnet provides the greatest magnetic force, and then the permanent magnet rotates, an angle of inclination of the contact plane 21 relative to the workpiece 200 becomes larger, and the magnetic force provided by the permanent magnet is reduced.

The handle 30 includes a rotating portion 31 within the mounting socket 14, and a handgrip 32 connected to the rotating portion 31 and protruding from the mounting socket 14.

The rotating portion 31 is rotatable about the predetermined axis relative to the guide seat 10, and the permanent magnet is fixedly mounted to the rotating portion 31 so that the permanent magnet and the rotating portion 31 are rotatable together about the predetermined axis relative to the guide seat 10.

In this embodiment, the permanent magnet is fixed to the rotating portion 31 via a screw 50, and the permanent magnet may be fixed to the rotating portion 31 by welding as appropriate.

The handgrip 32 is mounted to the guide seat 10 through a first positioning pin 60 and a second positioning pin 70. The first positioning pin 60 includes a stopper 61 and a shaft portion 62 arranged along the predetermined axis, wherein the stopper 61 abuts one side of the side surface 13, one end of the shaft portion 62 is connected to the stopper 61, and the other end of the shaft portion 62 penetrates the rotating portion 31 from one side of the side surface 13 and comes out from the other side of the side surface 13. The second positioning pin 70 penetrates the other end of the shaft portion 62 in a radial direction of the shaft portion 62 and abuts the other side of the side surface 13.

The guide portion 40 is provided on the side surface 13, the guide portion 40 is provided with a pilot hole 41, a center axis of the pilot hole 41 is perpendicular to the bottom surface 12, and the pilot hole 41 is configured for guiding the tap for threading in the workpiece 200.

A thread is provided in the pilot hole 41, and the thread in the pilot hole 41 aligns with a thread of the tap so that the tap does not wobble relative to the guide portion 40 in the pilot hole 41.

A depth of the pilot hole 41 ranges between 4 and 5 times a pitch of the thread in the pilot hole 41 so that an area where a wall of the pilot hole 41 contacts the tap is sufficient for piloting the tap and the friction generated cannot stop the spinning yet.

The guide portion 40 is spaced a predetermined distance from the plane of the bottom surface 12; when the magnetic tapping guide device 100 is guiding the tap for threading in the workpiece 200, a gap 203 exists between the guide portion 40 and the workpiece 200; by spacing the guide portion 40 the predetermined distance from the plane of the bottom surface 12, on the one hand, it is convenient to observe whether the bond between the tap and the workpiece 200 is at an accurate position and to discharge debris generated during tapping.

A plurality of the guide portions 40 may be provided, and the plurality of the guide portions 40 are arranged around the bottom surface 12. The pilot holes 41 of the plurality of the guide portions 40 are different in size so that the magnetic tapping guide device 100 can be useful for multiple types of holes.

In some other embodiments, the guide portion 40 is provided on the top surface, it should be noted that the guide portion 40 must be raised above the top surface so that the guide seat 10 does not prevent the tap from passing through the pilot hole 41 and contacting the workpiece during tapping.

The magnetic tapping guide device 100 may be used specifically by the following operations: attaching the bottom surface 12 to a machining surface 202 of the workpiece 200 having a machining hole 201 to be tapped, screwing the tap into a correspondingly sized pilot hole 41, and observing from the gap 203 between the guide portion 40 and the workpiece 200 to ensure that the tap is in the center of the machining hole 201 to be tapped; wrenching the handle 30 to maximize the contact area between the permanent magnet and the workpiece 200, keeping the bottom surface 12 fixed relative to the workpiece 200 by the magnetic force provided by the permanent magnet, and starting to tap the workpiece 200 with the tap; and, wrenching the handle 30 reversely to minimize the contact surface between the permanent magnet and the workpiece 200 after the tapping is completed, in which case the magnetic force provided by the permanent magnet is reduced and it is possible to separate the magnetic tapping guide device 100 from the workpiece 200.

With reference to FIG. 4, another embodiment of the present application provides a magnetic tapping guide device 300, which is substantially the same as the magnetic tapping guide device 100 provided in the previous embodiment and differs in that the magnetic module 20 of the magnetic tapping guide device 300 in this embodiment is an electromagnet.

With the current applied to the electromagnet varied, the magnetic force provided by the electromagnet is made adjustable.

The guide seat 10 has an overall flat cylindrical shape, and the handle 30 has an overall elongated cylindrical shape, with the center line of the handle 30 coinciding with the center line of the guide seat 10 so as to facilitate gripping the handle 30.

One end of the handle 30 is connected to the guide seat 10, the other end of the handle 30 is provided with a plug 80, the plug 80 is connected to the handle 30 via a transmission cable 81, and the plug 80 is used for supplying power to the electromagnet.

The end of the handle 30 away from the guide seat 10 is further provided with a change-over switch 90 for changing the current applied to the electromagnet.

The magnetic tapping guide device 300 may be used specifically by the following operations: attaching the bottom surface 12 to a machining surface 202 of the workpiece 200 having a machining hole 201 to be tapped, screwing the tap into a correspondingly sized pilot hole 41, and observing from the gap 203 between the guide portion 40 and the workpiece 200 to ensure that the tap is in the center of the machining hole 201 to be tapped; supplying power to the electromagnet via the plug 80 and pressing the change-over switch 90 to energize the electromagnet, keeping the bottom surface 12 fixed relative to the workpiece 200 by the magnetic force provided by the electromagnet, and starting to tap the workpiece 200 with the tap; and, resetting the change-over switch 90 after the tapping is completed, de-energizing the electromagnet, in which case the magnetic force provided by the electromagnet disappears and it is possible to separate the magnetic tapping guide device 300 from the workpiece 200.

The magnetic tapping guide device 300 differs from the magnetic force tapping guide device 100 provided in the previous embodiment in that the magnetic module 20 in the magnetic force tapping guide device 100 of the previous embodiment is a permanent magnet, in which case even if the magnetic force provided by the permanent magnet is minimized by rotating the permanent magnet, the magnetic force remains still to an extent, causing a resistance against adjusting the position of the guide seat 10 to align the pilot hole 41 with the machining hole 201 to be tapped. In the magnetic tapping guide device 300 provided in this embodiment, the magnetic module 20 is an electromagnet, once the electromagnet is de-energized, the magnetic force provided by the electromagnet completely disappears, and there is no resistance in the process of adjusting the position of the guide seat 10 to align the pilot hole 41 with the machining hole 201 to be tapped, so the adjustment of the position of the guide seat 10 is convenient.

Compared with the related art, the embodiments of the present application provide a magnetic tapping guide device 100, 300, wherein the magnetic force provided by the magnetic module 20 is adjustable, and after the magnetic force provided by the magnetic module 20 is tuned lower, the position of the magnetic tapping guide device 100, 300 is easily adjusted.

The above description is merely an embodiment of the present application, and does not limit the scope of the present application. Any equivalent structural or process changes based on the disclosure of the description and the drawings of the present application or direct or indirect use of the present application in other relevant technical fields are likewise included in the scope of the present application.

What is claimed is:

1. A magnetic tapping guide device, configured to guide a tap for threading in a workpiece, and comprising:
a guide seat configured to contact with the workpiece;
a guide portion positioned outside the guide seat, the guide portion having a pilot hole for guiding the tap; and
a magnetic module positioned inside the guide seat, the magnetic module being configured to provide a magnetic force to keep the guide seat in contact with the workpiece, the magnetic force of the magnetic module being adjustable.

2. The magnetic tapping guide device according to claim 1, wherein the guide seat has a top surface, a bottom surface, and a side surface;
the top surface and the bottom surface are opposite, the side surface is between the top surface and the bottom surface, and the side surface encloses the bottom surface;
the bottom surface is configured to contact with the workpiece;
the guide portion is provided on the side surface or the top surface.

3. The magnetic tapping guide device according to claim 2, wherein the magnetic module is a permanent magnet;
the permanent magnet is rotatable relative to the guide seat to change an area where the permanent magnet contacts the workpiece.

4. The magnetic tapping guide device according to claim 3, further comprising a handle;
the handle is rotatable relative to the guide seat, and the permanent magnet is fixedly mounted to the handle.

5. The magnetic tapping guide device according to claim 4, wherein the guide seat is provided with a mounting socket;
the mounting socket penetrates the top surface and the bottom surface;
the permanent magnet is positioned in the mounting socket;
the handle includes a rotating portion mounted in the mounting socket, and a handgrip connected to the rotating portion; the handgrip extends out of the mounting socket, the rotating portion is rotatable relative to the guide seat, and the permanent magnet is fixedly mounted on the rotating portion.

6. The magnetic tapping guide device according to claim 2, wherein the magnetic module is an electromagnet that varies the magnetic force provided by the electromagnet corresponding to varied current applied to the electromagnet.

7. The magnetic tapping guide device according to claim 6, wherein the magnetic tapping guide device is provided with a plug through which the electromagnet is powered.

8. The magnetic tapping guide device according to claim 2, wherein a thread is provided in the pilot hole; and
a depth of the pilot hole ranges between 4 and 5 times a pitch of the thread in the pilot hole.

9. The magnetic tapping guide device according to claim 2, wherein a plurality of the guide portions are provided, and the pilot holes of the plurality of the guide portions are different in size.

10. The magnetic tapping guide device according to claim 2, wherein the guide portion is spaced a predetermined distance from a plane of the bottom surface.
